(19) United States
(12) Patent Application Publication
(10) Pub. No.: US 2009/0196032 A1
(43) Pub. Date: Aug. 6, 2009

(54) ILLUMINATED SIGN DISPLAY ASSEMBLY

(75) Inventors: Shou Hsiu Hsu, Taipei (TW); Kuo Hsun Huang, Taipei (TW); Yu Liang Liu, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTek Computer Inc., Taipei (TW)

(21) Appl. No.: 12/325,549

(22) Filed: Dec. 1, 2008

(30) Foreign Application Priority Data
Feb. 5, 2008 (TW) 097104465

(51) Int. Cl. F21V 9/00; F21V 7/00

(52) U.S. Cl. 362/231; 362/235

(57) ABSTRACT

The invention discloses an illuminated sign display assembly including a transparent substrate, a multilayer circuit structure, a light reflecting casing, and at least one light emitting unit. The multilayer circuit structure is disposed on the transparent substrate, and a hollow portion is formed on the multilayer circuit structure. The light reflecting casing is fixed on the transparent substrate by a welding process and covers the hollow portion of the multilayer circuit structure. The light emitting unit is disposed on the transparent substrate and located in the light reflecting casing. The light reflecting unit is electrically connected to the multilayer circuit structure. Once the multilayer circuit structure is powered on, the light emitted by the light emitting unit will be reflected by the light reflecting casing and then passes through the hollow portion of the multilayer circuit structure and the transparent substrate, so as to form an illuminated sign.

### BACKGROUND OF THE INVENTION

1. Field of the Invention

The invention relates to an illuminated sign display assembly and, more particularly, to an illuminated sign display assembly made via a circuit board.

2. Description of the Prior Art

Nowadays, all electronic products are equipped with circuit boards to transmit various circuit signals. Generally speaking, manufacturers print various patterns, letters or characters on circuit boards to provide corresponding information for users. For example, a corresponding product model is often printed on a circuit board. When the circuit board has errors, a user may quickly know about the product model of the used circuit board, and he or she may correctly make the circuit board maintained or replaced. In addition, manufacturer also may print a company sign thereof on a circuit board to publicize and advertise itself.

To attract consumers, casings of many electronic devices are designed to be transparent. Thus, the consumers may directly see electronic parts in the electronic devices. In other words, for users, the chance of seeing circuit boards hid in a casing increases.

For conventional technology, if company signs, other letters, characters and so on need to be printed on circuit boards, they are printed in two modes which are copper foil etching (first) and oil printing (second). However, since mostly circuit boards in electronic devices are in an environment without sufficient light, the two modes cannot achieve esthetical effect and striking visual effect. Now, many publications prove that strong illumination is beneficial to attract attention. However, the method for showing patterns on circuit boards via light needs a complex structure and a high cost.

Therefore, the invention provides an illuminated sign display assembly adapted to a circuit board to solve the problems.

### SUMMARY OF THE INVENTION

The invention provides an illuminated sign display assembly, which shows illuminated sign on a surface of a circuit board to attract attention of users.

According to an embodiment, the illuminated sign display assembly of the invention includes a transparent substrate, a multilayer circuit structure, a light reflecting casing and at least a light emitting element.

The multilayer circuit structure is disposed on the transparent substrate, and a hollow portion is formed on the multilayer circuit structure. The hollow portion may be designed to show patterns of company signs, letters, characters, and so on. The un-hollow portion outside the hollow portion also may be designed to show patterns of company signs, letters, characters, and so on. This depends on actual application.

In the embodiment, the light reflecting casing is fixed on the transparent substrate via a welding process, and it covers the hollow portion. In addition, the light emitting element is disposed on the transparent substrate and located in the light reflecting casing. The light emitting element is electrically connected to the multilayer circuit structure. When the multilayer circuit structure is powered on, the light emitted by the light emitting element is reflected via the light reflecting casing, and then it emits out of the transparent substrate from the hollow portion of the multilayer circuit structure. Thus, the illuminated sign may be displayed on the circuit board to attract attentions of users.

The invention further provides an illuminated sign display assembly. A light reflecting casing is disposed at the back of the circuit board, and it is used to display illuminated sign to attract attention of users.

According to an embodiment, the illuminated sign display assembly of the invention includes a circuit board, a light reflecting casing, a transparent member and at least a light emitting element.

In the embodiment, the light reflecting casing is fixed on the circuit board by a welding process. A hollow portion is formed on a surface of the light reflecting casing. The hollow portion may be designed to show patterns of company signs, letters and characters and so on.

In addition, the light emitting element is disposed on the circuit board and located in the light reflecting casing. The light emitting element is electrically connected to the circuit board. When the circuit board is powered on, the light emitted by the light emitting element emits out of the transparent member from the hollow portion of the light reflecting casing. Thus, the illuminated sign may be displayed on the back of the circuit board to attract attentions of users.

In actual application, the light reflecting casing may be fixed on the circuit board via a conventional welding process such as a surface mount technology (SMT) process or dual in-line package (DIP) process. Therefore, the illuminated sign display assembly according to the invention has following advantages. First, the manufacturing cost is low. Second, the amount of material just needs to meet the demand of a general mass production, and the manufacturing process is easy and convenient. Third, special transparent light-guiding material is not needed.

These and other features, aspects, and advantages of the present invention will become better understood with regard to the following description, appended claims, and accompanying drawings.

### BRIEF DESCRIPTION OF THE APPENDED DRAWINGS

FIG. 1 is a top view showing the illuminated sign display assembly according to an embodiment of the invention;

FIG. 2 is a bottom view showing the illuminated sign display assembly in FIG. 1;

FIG. 3 is a schematic diagram showing that the light reflecting casing in FIG. 2 is not welded to the circuit board;

FIG. 4 is a back view showing an illuminated sign display assembly according to another embodiment of the invention;

FIG. 5 is a schematic diagram showing that the light reflecting casing in FIG. 4 is not welded to the circuit board; and

FIG. 6 is a schematic diagram showing an illuminated sign display assembly according to another embodiment of the invention.

### DETAILED DESCRIPTION OF THE INVENTION

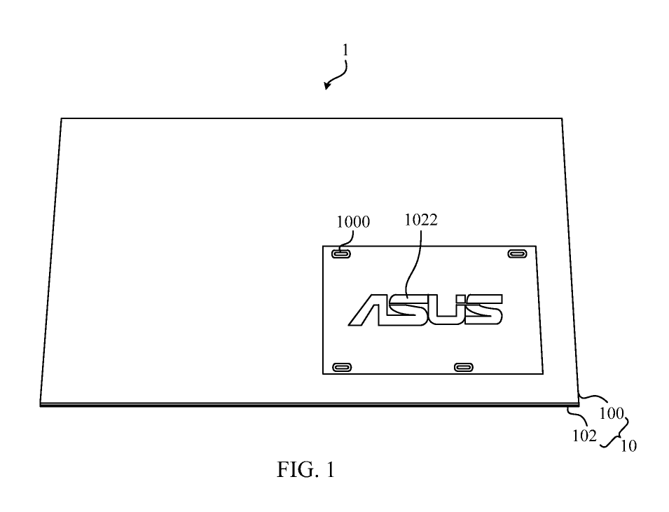

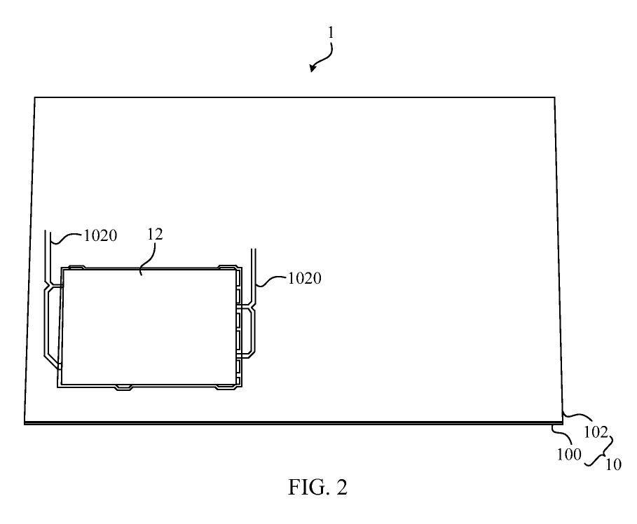

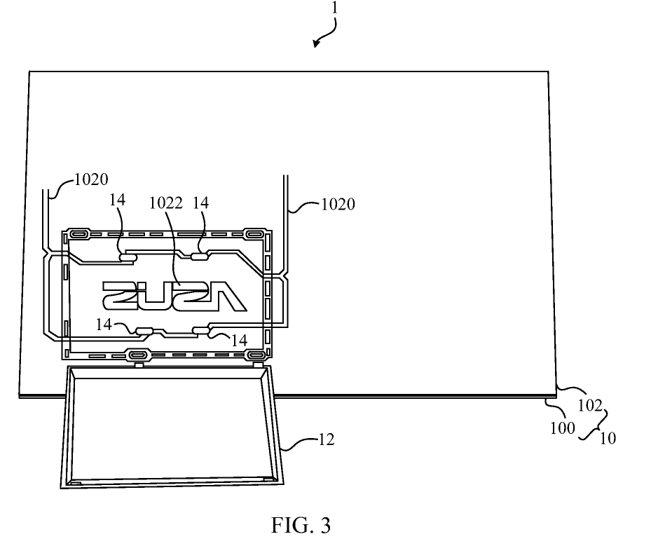

FIG. 1 is a top view showing an illuminated sign display assembly 1 according to one embodiment of the invention. FIG. 2 is a bottom view showing the illuminated sign display assembly 1 shown in FIG. 1. FIG. 3 is a schematic diagram showing that the light reflecting casing 12 shown in FIG. 2 is not welded to the circuit board 10.

As shown in FIG. 1 to FIG. 3, the illuminated sign display assembly 1 of the preferred embodiment of the invention includes a circuit board 10, a light reflecting casing 12 and four light emitting elements 14. Four light emitting elements 14 are shown in FIG. 3. However, the number of the light emitting elements 14 can be adjusted according to the actual application, and it is not limited to four. The light emitting elements 14 may be light emitting diodes (LED), organic light emitting displays (OLED) or other similar elements which may emit light.

The circuit board 10 further includes a transparent substrate 100 and a multilayer circuit structure 102. In the embodiment, the material of the transparent substrate 100 only needs to allow the light to be transmitted, and it is not limited. Generally speaking, the multilayer circuit structure 102 is composed of copper foils and is formed on the transparent substrate 100 via an electronic printing technology. The multilayer circuit structure 102 has a copper foil circuit 1020 for transmitting circuit signals. The circuit board 10 may be a printed circuit board (PCB) or a flexible printed circuit (FPC). The relative manufacturing technology of the circuit board is easily achieved by people having ordinary skills, and it is not described herein.

As shown in FIG. 1 or FIG. 3, the hollow portion 1022 is formed on the multilayer circuit structure 102. The hollow portion 1022 may be designed to show patterns such as company signs (such as “ASUS” letters in FIG. 1 and FIG. 3), letters or characters.

In actual application, the patterns, such as company signs, letters or characters, which need to be shown on the multilayer circuit structure 102 may be remained, and the portion which is not needed is hollowed. In other words, the letter “ASUS” (namely, reference number 1022) shown in FIG. 1 or FIG. 3 also may be an un-hollow portion, and the periphery of the letter is hollowed.

In the embodiment, the light reflecting casing 12 is fixed at the transparent substrate 100 via a welding process, and it covers the hollow portion 1022. For example, the light reflecting casing 12 may be fixed on the circuit board 10 via a conventional welding process such as a surface mount technology (SMT) process or a dual in-line package (DIP) process. If the light reflecting casing 12 is welded on the transparent substrate 100 via the DIP, the surface of the transparent base 100 has holes 1000 used by connectors, as shown in FIG. 1. Since the holes 1000 on the surface of the transparent substrate 100 affects esthetics, in the embodiment of the invention, the light reflecting casing 12 may be welded on the transparent substrate 100 via the SMT. Thus, the surface of the transparent substrate 100 does not have holes 1000. In other embodiments, the light reflecting casing 12 also may be welded on the transparent substrate 100 via both the SMT process and DIP process to fix it firmly. The welding process is chosen according to the actual application.

In addition, the light emitting elements 14 are disposed on the transparent substrate 100 and located in the light reflecting casing 12. Each light emitting element 14 is electrically connected to the copper foil circuit 1020 of the multilayer circuit structure 102, respectively. When the multilayer circuit structure 102 is powered on, the light emitted by the light emitting elements 14 is reflected by the light reflecting casing 12, and then it emits out of the transparent substrate 100 via the hollow portion 1022 of the multilayer circuit structure 102. Thus, the illuminated sign may be shown on the circuit board 10 to attract attention of users.

In addition, in the embodiment of the invention, more than two light emitting elements 14 may be utilized to emit light with different colors for showing different operating states. For example, when the light emitting element 14 emits red light, the corresponding operating state may be set to be “overclocking”. When the light emitting element 14 emits blue light, the corresponding operating state may be set to be “sleeping”. When the light emitting element 14 emits the green light, the corresponding operating state is “working”. Other conditions may be known by analog. Therefore, not only manufacturers may reinforce publicizing and advertising effect via the illuminated sign, and users also may know about the operating state of the electronic device via variance of the color of light.

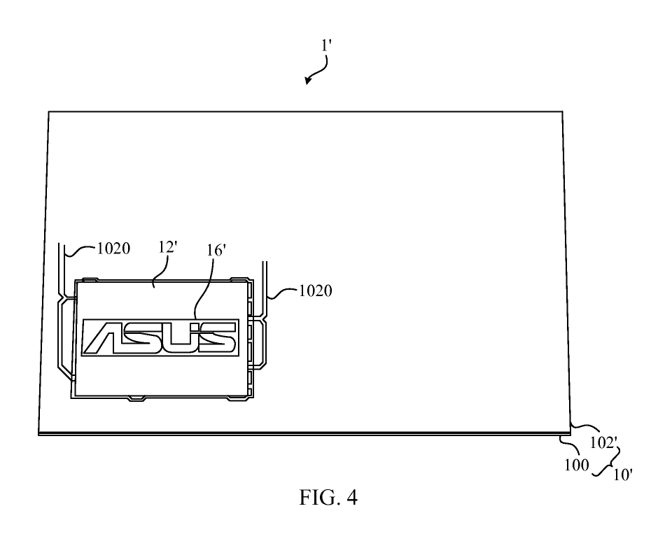

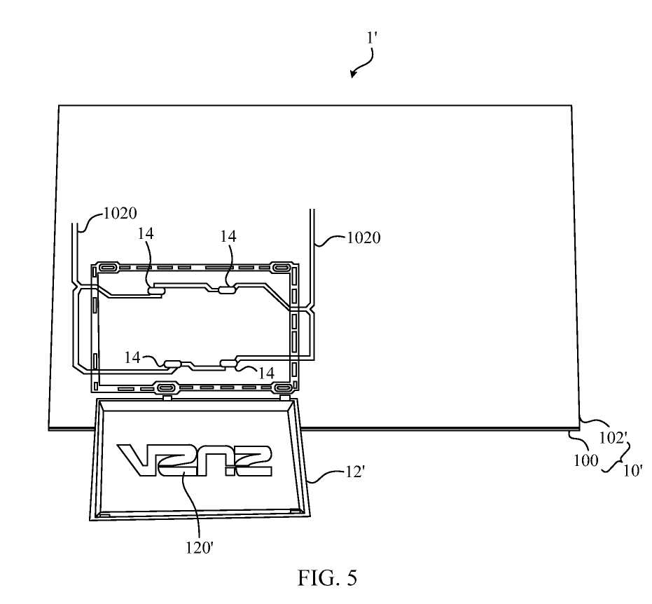

FIG. 4 is a back view showing the illuminated sign display assembly 1′ according to another embodiment of the invention. FIG. 5 is a schematic diagram showing that the light reflecting casing 12′ shown in FIG. 4 is not welded to the circuit board 10′. The main difference between the illuminated sign display assembly 1′ and the illuminated sign display assembly 1 is that the hollow portion 120′ is formed at the surface of the light reflecting casing 12′, and the multilayer circuit structure 102′ of the circuit board 10′ does not have the hollow portion. In addition, the illuminated sign display assembly 1′ further includes a transparent member 16′ disposed at the surface of the light reflecting casing 12′. The transparent member 16′ also may be disposed on the inner surface of the light reflecting casing 12′, which depends on the actual application. The principle of the illuminated sign display assembly 1′ in FIG. 4 is the same with the illuminated sign display assembly 1, and it is not described for concise purpose herein.

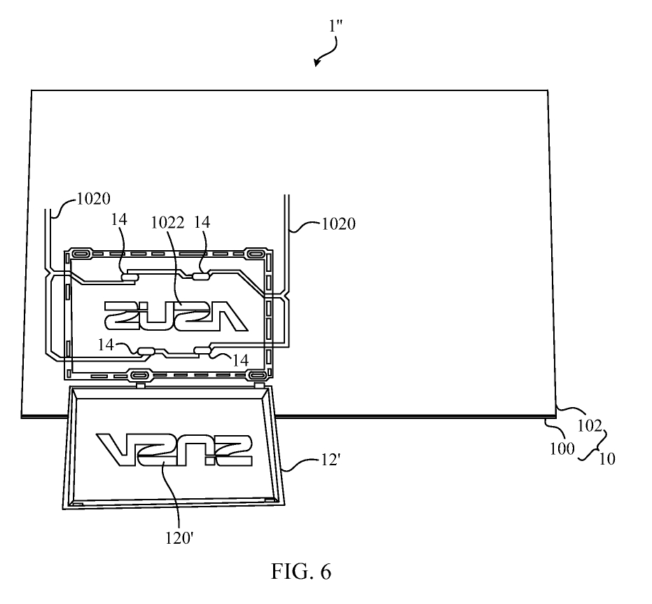

FIG. 6 is a schematic diagram showing an illuminated sign display assembly 1″ according to another embodiment of the invention. The difference between the illuminated sign display assembly 1″ and the illuminated sign display assembly 1 is that not only the multilayer circuit structure 102 has the hollow portion 1022, the light reflecting casing 12′ also has a hollow portion 120′. Thus, a user may see the illuminated sign from the front or the back of the circuit board 10, and a manufacturer does not need to worry about that the illuminated sign would be blocked by other electronic devices when the circuit board 10 is installed to the electronic device. The working principle of the illuminated sign display assembly 1″ is the same with the illuminated sign display assembly 1, which is not described for concise purpose herein.

Compared with the conventional technology, for the illuminated sign display assembly of the invention, since the light reflecting casing may be fixed on the circuit board via a conventional welding process such as a SMI process or DIP process, the illuminated sign display assembly of the invention has following advantages. First, the manufacturing cost is low. Second, the amount of material just needs to meet a general mass production, and the producing method is easy. Third, special transparent light-guiding material is not needed. In addition, the illuminated sign not only has effects such as being esthetical, publicizing and advertising, it also may inform a user of the operating state of the electronic device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An illuminated sign display assembly, comprising:
a transparent substrate having a multilayer circuit structure on which a first hollow portion is formed;
a light reflecting casing fixed on the transparent substrate and covering the first hollow portion; and
at least a light emitting element disposed on the transparent substrate, covered by the light reflecting casing, and electrically connected to the multilayer circuit structure.

2. The illuminated sign display assembly according to claim 1, wherein the light reflecting casing is fixed on the transparent substrate via a surface mount technology (SMT) process or a dual in-line package (DIP) process.

3. The illuminated sign display assembly according to claim 1, wherein a second hollow portion is formed on a surface of the light reflecting casing.

4. The illuminated sign display assembly according to claim 3, further comprising a transparent member disposed on the surface.

5. The illuminated sign display assembly according to claim 1, when the amount of the light emitting elements is equal or larger than two, the light emitting elements are capable of emitting lights with different colors.

6. An illuminated sign display assembly comprising:
a circuit board;
a light reflecting casing fixed on the circuit board, wherein a second hollow portion is formed on a surface of the light reflecting casing;
a transparent member disposed on the surface; and
at least a light emitting element disposed on the circuit board and located in the light reflecting casing.

7. The illuminated sign display assembly according to claim 6, wherein the circuit board comprises:
a transparent substrate; and
a multilayer circuit structure disposed on the transparent substrate, wherein a first hollow portion is formed on the multilayer circuit structure and is covered by the light reflecting casing.

8. The illuminated sign display assembly according to claim 6, wherein the light reflecting casing is fixed on the transparent substrate via a SMT process or a DIP process.

9. The illuminated sign display assembly according to claim 6, when the amount of the light emitting elements is equal or larger than two, the light emitting elements are capable of emitting lights with different colors.

10. The illuminated sign display assembly according to claim 6, wherein the light emitting element is a light emitting diode.
